(19) United States
(12) Patent Application Publication
(10) Pub. No.: US 2014/0071661 A1
(43) Pub. Date: Mar. 13, 2014

(54) ILLUMINATION SYSTEM AND METHOD

(71) Applicant: Carl Zealer, Canal Winchester, OH (US)

(72) Inventor: Carl Zealer, Canal Winchester, OH (US)

(21) Appl. No.: 14/024,253

(22) Filed: Sep. 11, 2013

Related U.S. Application Data
(60) Provisional application No. 61/699,548, filed on Sep. 11, 2012.

(51) Int. Cl. F21S 10/00; F21L 4/02

(52) U.S. Cl. CPC F21S 10/002; F21L 4/02
USPC 362/101; 362/184

(57) ABSTRACT

One or more embodiments of techniques or systems for generating illumination or enabling an illumination within a liquid (e.g., a sports or energy drink), container, straw, accents (e.g., drink cubes), etc. are provided. A vessel or container can illuminate a fluid that employs ultraviolet (UV) powder or other illuminable substances. In one or more aspects, a black light source can be provided in a base of a vessel, such as a cup or bottle. In others, the black light sources can be included within a stir stick, straw, vessel insulator/wrap, freezer treat stick, or cooling elements (e.g., faux ice cubes). In this way, one or more aspects or elements associated with a drink (e.g., serving platter, container, straw, lid, beverage, drink cubes) can be illuminated, thereby enhancing a user's beverage experience.

### CROSS-REFERENCE TO RELATED APPLICATIONS

This application claims the benefit of U.S. Provisional Patent Application Ser. No. 61/699,548 (Attorney Docket No. 104542.17PRO2) entitled “ILLUMINABLE BEVERAGE SYSTEM”, filed on Sep. 11, 2012. The entirety of the above-noted application is incorporated by reference herein.

### BACKGROUND

Generally, tonic water contains quinine, which is known to glow under ultraviolet (UV) light, otherwise known as “black light”. Effectively, a source of black light or black light source may be a fluorescent light that emits electromagnetic radiation in the soft near ultraviolet range. Other black light sources may include an incandescent bulb, mercury vapor lamp, or light-emitting diodes (LEDs). In operation, merely a small fraction of visible radiation is permitted to pass through a filtering material, with wavelengths no longer than 400-410 nanometers (nm). As a result, the human eye detects the color as deep blue and violet.

Black light sources have many uses. For example, black light sources may be used for decorative or artistic lighting effects, in connection with forensics, diagnostic or therapeutic uses in medicine, observation of substances that exhibit a fluorescent effect, curing plastic resins, attracting insects, tanning beds, etc. In addition to their UV properties, most ultraviolet sources are low power.

Quinine is a natural white crystalline alkaloid having antipyretic (e.g., fever-reducing), antimalarial, analgesic (e.g., painkilling), anti-inflammatory properties, and generally having a bitter taste. Though quinine has been synthesized in a lab, the bark of the cinchona tree is perhaps the most economical source of quinine. The medicinal properties of the cinchona tree were originally discovered by the Quechua Indians of Peru and Bolivia; later, the Jesuits were the first to bring the cinchona to Europe. In addition to its medicinal uses, quinine is sensitive to ultraviolet light (UV) and will fluoresce in direct sunlight as well as under black light, due to its highly conjugated resonance structure. As a result of these illuminating properties, tonic water has been used in novelty drinks. However, due to its distinct taste (which is an acquired taste for many), the use of tonic water is generally limited.

### BRIEF DESCRIPTION

This brief description is provided to introduce a selection of concepts in a simplified form that are described below in the detailed description. This brief description is not intended to be an extensive overview of the claimed subject matter, identify key factors or essential features of the claimed subject matter, nor is it intended to be used to limit the scope of the claimed subject matter.

One or more embodiments of techniques or systems for generating illumination or enabling illumination within a liquid (e.g., a sports or energy drink), a container, a straw, accents (e.g., drink cubes, faux ice cubes), etc. are provided. For example, an illumination system can illuminate a container which houses a drink or beverage, a sleeve (e.g., insulator or wrap) for the container, a lid, straw, stir stick, or other elements associated with the container, etc. In other aspects, a vessel or container capable of illuminating a fluid that employs ultraviolet (UV) powder or other illuminable substance is provided (e.g., a black light source at a base of a container, vessel, cup, bottle, etc.). In one or more embodiments, the illumination system can illuminate the beverage itself, such as by employing an ultraviolet (UV) powder which can cause a liquid to glow when combined, for example. As another example, the illumination system can illuminate drink cubes (e.g., faux ice cubes, ice cubes, whiskey stones, cooling elements, etc.) used to control a temperature of a beverage.

A vessel or container can illuminate a fluid that employs ultraviolet (UV) powder or other illuminable substances. In one or more aspects, a black light source can be provided in a base of a vessel, such as a cup or bottle. In others, the black light sources can be included within a stir stick, straw, vessel insulator/wrap, freezer treat stick, or cooling elements (e.g., faux ice cubes). In this way, one or more aspects or elements associated with a drink (e.g., serving platter, container, straw, lid, beverage, drink cubes) can be illuminated, thereby enhancing a user's beverage experience. As used herein, beverage can include most any liquid (e.g., consumable) and vice versa. In one or more embodiments, an illuminated liquid may not be consumable. Effectively, most any combination of a black light source and an illuminable substance can be implemented in a beverage, a liquid, a container, a vessel, a cup, a bottle, a straw, stir stick, accents, drink cubes, faux ice cubes, a sleeve, insulator, a wrap, a cooling element, a heating element, a temperature control component, etc.

The following description and annexed drawings set forth certain illustrative aspects and implementations. These are indicative of but a few of the various ways in which one or more aspects are employed. Other aspects, advantages, or novel features of the disclosure will become apparent from the following detailed description when considered in conjunction with the annexed drawings.

### BRIEF DESCRIPTION OF THE DRAWINGS

Aspects of the disclosure are understood from the following detailed description when read with the accompanying drawings. Elements, structures, etc. of the drawings may not necessarily be drawn to scale. Accordingly, the dimensions of the same may be arbitrarily increased or reduced for clarity of discussion, for example.

FIG. 1 is an illustration of an example block diagram of an illumination system, according to one or more embodiments.

FIG. 2 is an illustration of an example block diagram of an illumination system, according to one or more embodiments.

FIG. 3 is an illustration of an example flow diagram of a method for illuminating a liquid, according to one or more embodiments.

FIG. 4 is an illustration of an example illumination system employed within an illumination container, according to one or more embodiments.

FIG. 5 is an illustration of an example illumination system employed within an illumination container and an illumination straw or an illumination stir stick, according to one or more embodiments.

FIG. 6 is an illustration of an example illumination system employed within an illumination sleeve, according to one or more embodiments.

FIG. 7 is an illustration of an example illumination system employed within illumination drink cubes, according to one or more embodiments.

FIG. 8 is an illustration of an example illumination system employed within illumination drink cubes, according to one or more embodiments.

FIG. 9 is an illustration of an example illumination system employed in a freezer treat, according to one or more embodiments.

### DETAILED DESCRIPTION

Embodiments or examples, illustrated in the drawings are disclosed below using specific language. It will nevertheless be understood that the embodiments or examples are not intended to be limiting. Any alterations and modifications in the disclosed embodiments, and any further applications of the principles disclosed in this document are contemplated as would normally occur to one of ordinary skill in the pertinent art.

For one or more of the figures herein, one or more boundaries, may be drawn with different heights, widths, perimeters, aspect ratios, shapes, etc. relative to one another merely for illustrative purposes, and are not necessarily drawn to scale. For example, because dashed or dotted lines may be used to represent different boundaries, if the dashed and dotted lines were drawn on top of one another they would not be distinguishable in the figures, and thus may be drawn with different dimensions or slightly apart from one another, in one or more of the figures, so that they are distinguishable from one another. As another example, where a boundary is associated with an irregular shape, the boundary, such as a box drawn with a dashed line, dotted lined, etc., does not necessarily encompass an entire component in one or more instances. Conversely, a drawn box does not necessarily encompass merely an associated component, in one or more instances, but can encompass a portion of one or more other components as well.

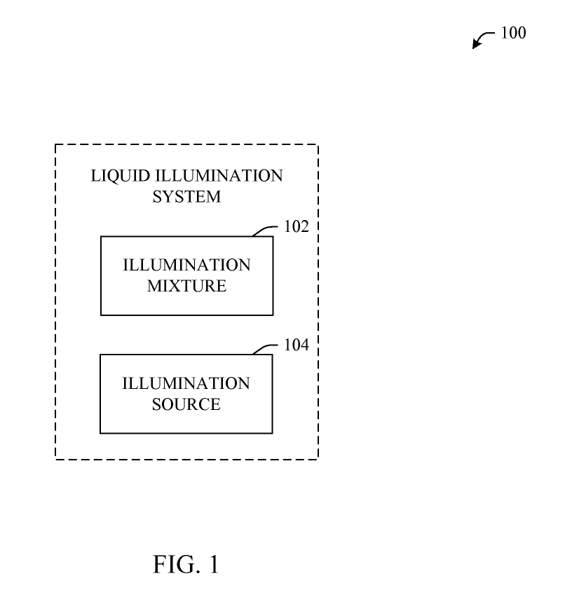

FIG. 1 is an illustration of an example block diagram of an illumination system 100, according to one or more embodiments. Generally, an illumination system 100 can include an illumination mixture 102 and an illumination source 104. In one or more embodiments, the illumination mixture 102 can include ultraviolet (UV) powder, UV flakes, or most any other substance capable or suitable for illumination under UV lighting, such as illumination particles, etc. In one or more embodiments, the illumination mixture 102 can be a powder, a liquid containing one or more illumination particles, a solid (e.g., containing illumination particles) which may dissolve in a liquid, etc. The illumination source 104 can include most any UV light source including, but not limited to, black lights, light-emitting diodes (LEDs), fluorescent lighting, incandescent lighting, or the like. It will be appreciated that in one or more embodiments, the illumination mixture 102 and the illumination source 104 may be implemented within the same component. For example, with reference to a “frosty freezer mug”, a first portion of a mug, such as a base of the mug, may have or include the illumination source 104 and a corresponding power source, while a second portion of the mug, such as a liquid encased within the mug, can include the illumination mixture 102.

In other embodiments, the illumination mixture 102 and the illumination source 104 may be implemented as disparate components. That is, a container, such as a mug, may contain or include the illumination source 104, while a beverage, such as a consumable beverage or liquid, can include the illumination mixture 102. Again, a variety of combinations of illumination sources 104, such as a black light source, and illuminable substances or illumination mixtures 102 may be implemented. For example, the illumination source 104 or the illumination mixture 102 may be implemented within a beverage, a liquid, a container, a vessel, a cup, a bottle, platter, serving platter, a straw, stir stick, accents, drink cubes, faux ice cubes, a sleeve, insulator, a wrap, a cooling element, a heating element, a temperature control component, etc.

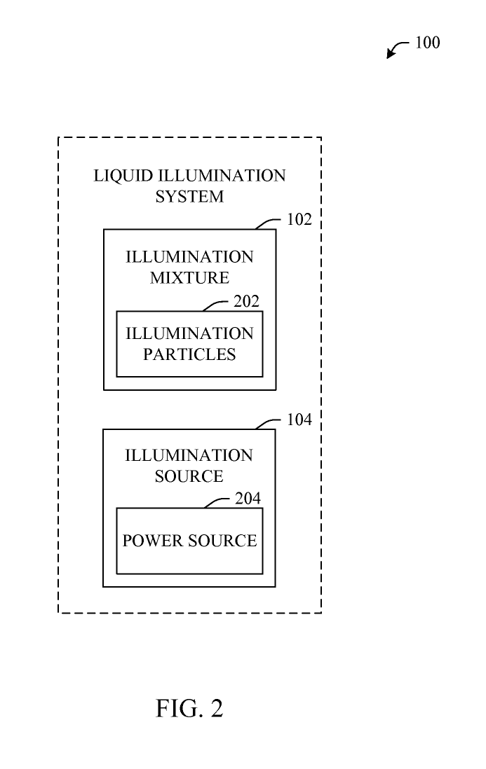

FIG. 2 is an illustration of an example block diagram of an illumination system 100, according to one or more embodiments. In one or more embodiments, the illumination mixture 102 can include one or more illumination particles 202, such as UV powder, or the like. Generally, UV powder can be a product that glows when exposed to UV light (e.g., black light). As an example, these UV particles can have a white color or a light-green color. When the UV particles are exposed to UV light, these powders or particles can glow in a variety of colors including, but not limited to, green, blue, yellow, purple, red, violet, etc. In operation, when a UV light, such as the illumination source 104, is applied to the illumination mixture 102, illumination particles 202, a similar substance, or a similar mixture, the powders, mixtures 102, or particles 202 glow. Similarly, upon removal of the light or illumination source 104, the glowing effect may subside.

In one or more embodiments, the illumination source 104 can include a power source 204. The power source 204 can include a battery, a solar panel, or one or more solar cells, etc. In one or more embodiments, the power source 204 can be removable or replaceable, while in other embodiments, the power source 204 may be integrated with the illumination source 104. That is, the illumination source 104 may include a non-replaceable power source 204, such that the system 100 is effectively a “throw-away” or disposable device, once power is expended. For example, the solar panel or solar cells can charge the battery or power source 204 while light is available, thereby enabling the power source 204 to supply electrical energy for the illumination source 104 during periods of darkness.

As will be shown and described, the illumination source 104, can be embedded into a container, cup/glass, bottle, stir stick, straw, novelty ice cubes, or the like. In operation, an on/off switching device can be provided to manually toggle the light source on/off. That is, the illumination source 104 can include a switch which enables a user to enable or disable the illumination source 104, such as by forming an electrical connection between the power source 204 and a black light source of the illumination source 104, for example. Effectively, the switch could operate as an on/off switch for the illumination source 104.

Similarly, sensors can be used, for example, to sense brightness, motion, position, temperature, or the like, to toggle the light source on/off. Additionally, presence or lack of liquid can also toggle the light source, thereby illuminating the UV properties of a liquid. While UV powder is disclosed herein, in one or more embodiments, liquids with natural illuminating properties, e.g., tonic water may be utilized or implemented. For example, the illumination source 104 could include one or more sensors that enable automatic activation of the illumination source 104, such as during darkness, based on a threshold (e.g., activation when less than 300 lumens are detected). As an example, the sensors could be configured to activate the switch to form an electrical connection between the power source 204 and the illumination source 104 when a light threshold is reached. In this way, the liquid illumination system 100 of FIG. 2 or FIG. 1 can automatically illuminate the illumination mixture 102 via activating the illumination source 104.

In other embodiments, the sensors may be activated based on a level of a drink or an amount of beverage remaining in a cup. This could be utilized to enable staff or servers to see when a customer or a client needs a refill, for example. In one or more embodiments, the lower the drink level or amount of beverage in a container, the brighter the illumination source 104 could be. In other embodiments, when a sensor senses that little to no drink, liquid, or beverage is remaining, the illumination source 104 can be configured to flash, etc. Further, an audio component may play a sound to facilitate notification that the drink is empty. In one or more embodiments, the illumination source 104 may have one or more moving components. For example, the illumination source 104 could include a rotating base or have spot light type components which illuminate beams of light within or across the illumination mixture 102.

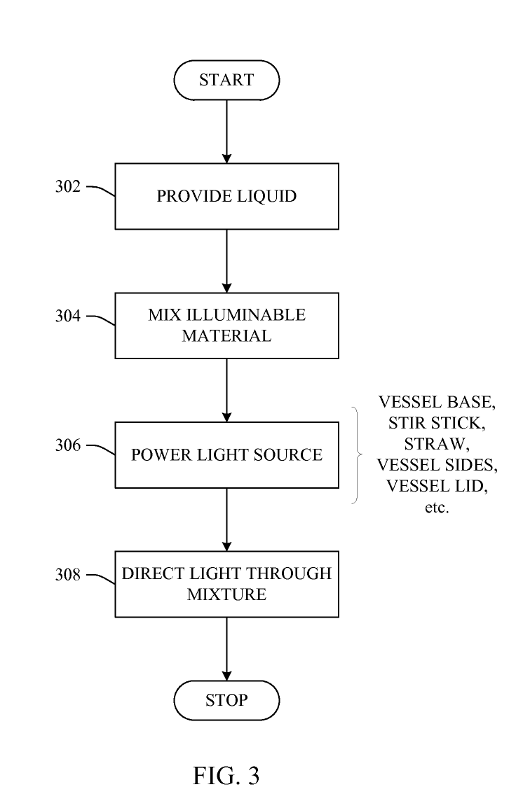

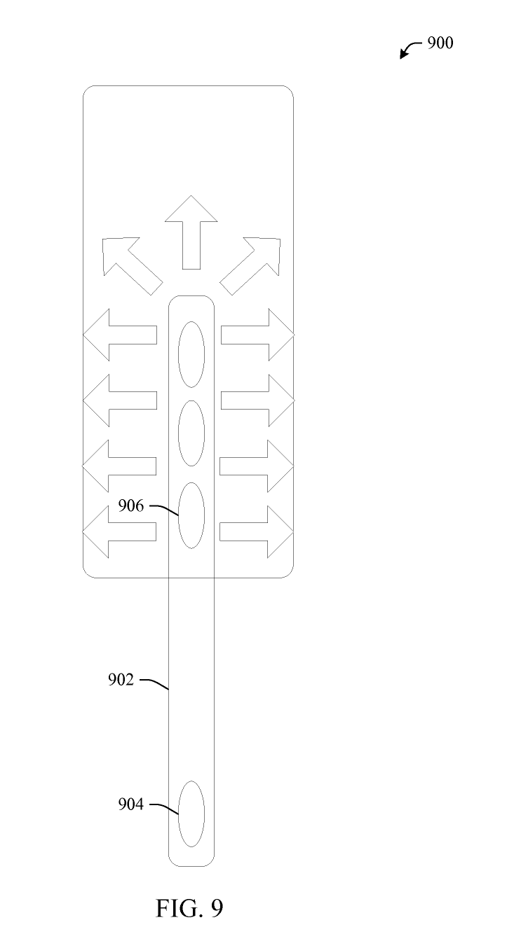

FIG. 3 is an illustration of an example flow diagram of a method for illuminating a liquid, according to one or more embodiments. At 302, a liquid is provided. For example, a glass of water may be provided. As another example, a beverage, such as a soda, beverage, carbonated beverage, etc. may be provided. In one or more embodiments, most any liquid can be employed. Although ingestible liquids are discussed herein, other embodiments can employ non-ingestible liquids, as appropriate or when desired. For example, the liquid encased within a frosty freeze mug can be provided, which is not necessarily consumable or ingestible. Illuminable material or illumination particles (e.g. UV powder, UV flakes, etc.) can be mixed with the liquid at 304. In one or more embodiments, the UV material can pre-mixed with the liquid. As well, aspects can be employed in connection with frozen liquids, which can be solid (e.g., frozen treats, as will be described with reference to FIG. 9). Accordingly, a liquid, as used herein can include frozen liquids, solids, etc. For example, a vessel base, stir stick, straw, vessel sides, vessel lid, frozen treat “stick,” etc. can be illuminated with an illumination source having or including a black light or black light source. A UV light source or illumination source can be provided, illuminated, or powered on at 306. Again, illumination or power may be provided based on a detected amount of light, a beverage level, a switch, etc. The light can then directed through the mixture at 308, thereby illuminating the illumination particles via the UV properties of the mixture, particles, fluid, etc. In this way, UV powder or inherent properties of the UV powder can be utilized to illuminate an illumination system, beverage, liquid, container, accents, accessories, lids, straws, drink cubes, faux ice cubes, etc.

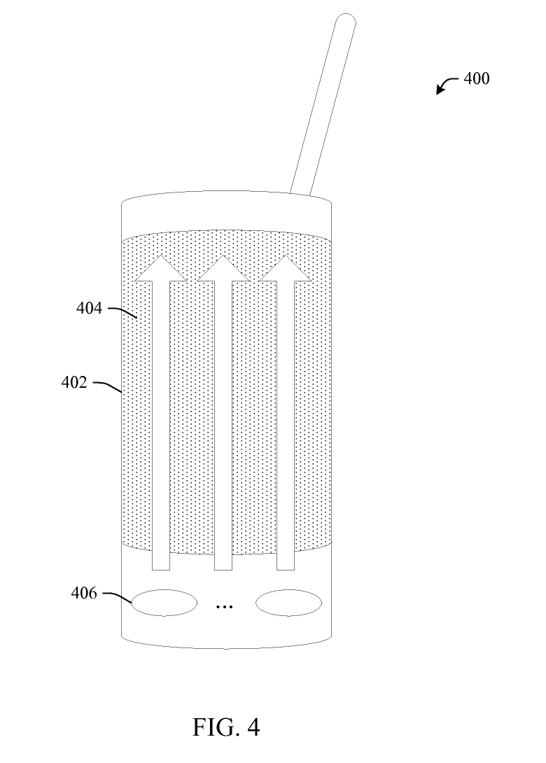

FIG. 4 is an illustration of an example illumination system 400 employed within an illumination container, according to one or more embodiments. In one or more embodiments, a can, glass, container, or other vessel 402 can retain or hold an illuminable liquid 404 (e.g. having illumination mixture 102 of FIG. 1 or FIG. 2). Here, the illuminable liquid 404 can be mixed with, for example, the UV powder, the illumination mixture 102 of FIG. 1 or FIG. 2, or the illumination particles of FIG. 2, thereby enabling, creating, or enhancing illuminable properties of the illuminable liquid 404. One or more light sources 406 can be provided, such as at the base of the vessel 402. One or more of the light sources 406 can be the same as the illumination source 104 of FIG. 1 or FIG. 2, for example. In operation, as illustrated, UV light or black light can be projected in the direction, as indicated by the arrows, thereby illuminating the illuminable liquid 404. Activation of one or more of the light sources 406 can be manual (e.g., switched by hand) or automatic (e.g., motion sensors, temperature sensors, light sensors, volume sensors, etc.) as appropriate or desired.

In one or more embodiments, the vessel 402 can have a rotating base such that one or more of the light sources 406 or illumination sources rotate or move. In other embodiments, the light sources 406 or illumination sources can shine light through the illuminable liquid 404 as a beam. When these light sources 406 move, this may cause the direction of the arrows to vary accordingly. In other words, the light sources 406 may have a variable angle, adjustable focus, a motorized iris, rotating prism, etc. Further, the light sources 406 or illumination sources may be configured to turn on or off sequentially, based on a pattern, or based on a sensor input, etc.

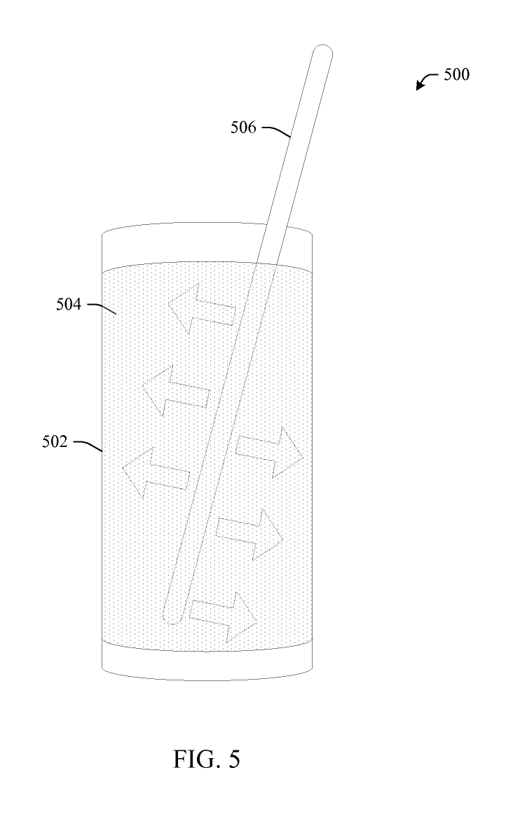

FIG. 5 is an illustration of an example illumination system 500 employed within an illumination container and an illumination straw or an illumination stir stick, according to one or more embodiments. In one or more embodiments, the illumination system 500 can include a vessel 502 (e.g., glass, bottle, cup, container, etc.) that is capable of retaining a volume of fluid. In this example, a stir stick or straw 506 can be provided. The stir stick or straw 506 can be equipped with an illumination source, a black light source, or a UV light source (e.g., LEDs). As indicated by the arrows, the light can be projected or distributed into the illuminable liquid 404 in one or more directions along the arrows (e.g., and in additional or other directions), thereby illuminating the illuminable liquid 404. As described herein, activation can be manual or automatic as appropriate or as desired. In one or more embodiments, the stir stick or straw 506 can include one or more rotating segments. In other embodiments, an illumination source or black light source can travel from one end of the straw 506 to the other.

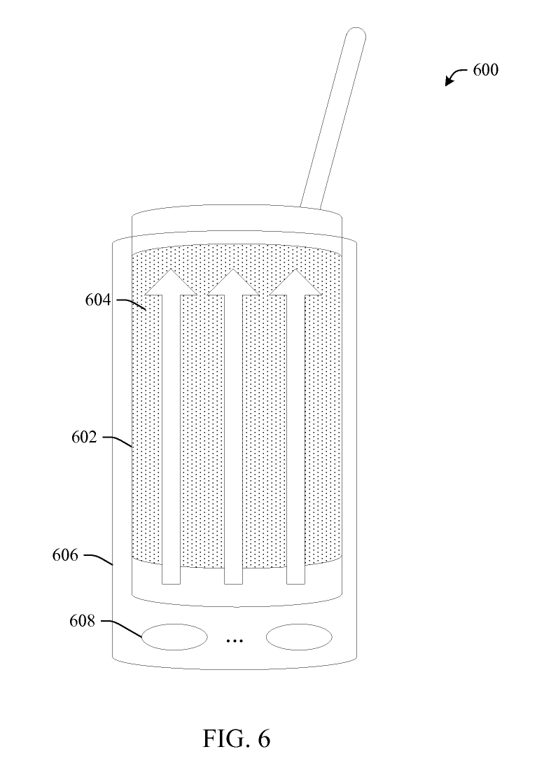

FIG. 6 is an illustration of an example illumination system 600 employed within an illumination sleeve, according to one or more embodiments. In one or more embodiments, the illumination system 600 can include a vessel 602 configured to retain an amount of illuminable fluid 604. Here, a sleeve 606 can be equipped with a UV light source or one or more illumination sources and placed around the vessel 602. The sleeve 606 can be equipped with one or more illumination sources 608, such as a UV light source, LEDs, etc., that can project black light or light into the illuminable fluid 604 or beverage. In this way, the illuminable fluid 604 can be illuminated under the black light of one or more of the illumination sources 608. In one or more embodiments, the sleeve 606 can include one or more windows, be transparent, or include one or more areas such that a glow associated with the illuminable fluid 604 as a result of the illumination sources 608 can be seen.

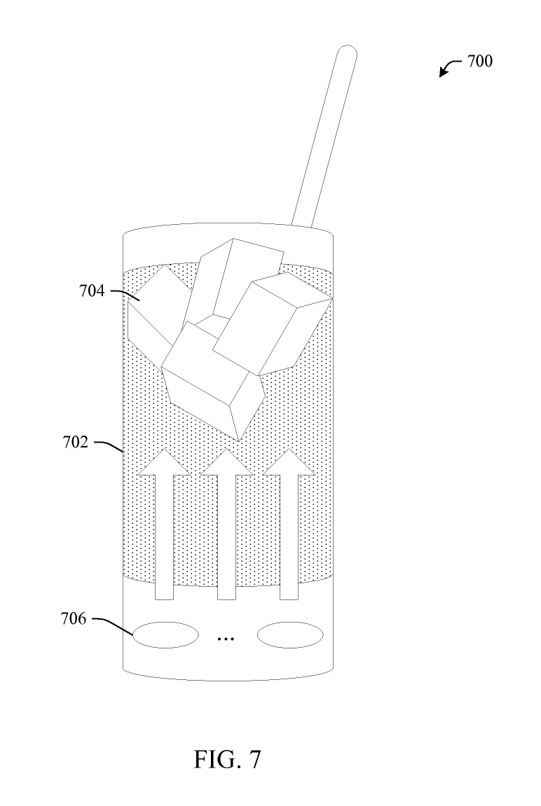

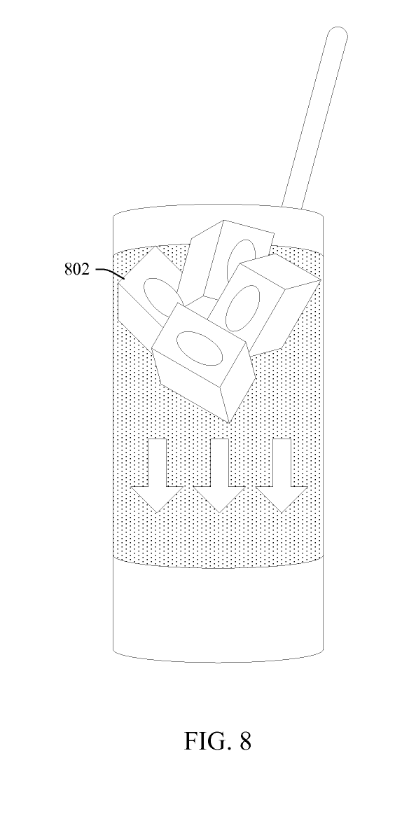

FIG. 7 and FIG. 8 illustrate illumination systems that respectively employ “ice cubes” (e.g., cooling elements, faux ice cubes, ice cubes containing illumination particles, other frozen liquid containing illumination particles, etc.) that can either illuminate or provide a source of UV light for illumination of illuminable fluid.

FIG. 7 is an illustration of an example illumination system 700 employed within illumination drink cubes, according to one or more embodiments. In one or more embodiments, the illumination system 700 can include a vessel 702 configured to hold a volume of fluid or illuminable fluid having one or more drink cubes 704, wherein one or more of the drink cubes 704 are capable of being illuminated by black light. In other words, the illuminable fluid or drink cubes can contain or include an illuminable material or one or more illuminable particles (e.g., UV powder). As a result, when one or more illumination sources 706 project UV light or black light (e.g., as indicated by the arrows), the illuminable fluid, or one or more of the drink cubes can illuminate.

According to one or more aspects, multiple colors may be employed to, for example, light one or more drink cubes in different colors from one or more other drink cubes from one another or in a different color than the illuminable fluid. Additionally, the drink cubes 704 can be faux ice cubes (e.g., cooling packs) that include illuminable material, illumination particles, or are colored in a manner such that the drink cubes 704 illuminate under UV light, black light, or illumination sources 706. Accordingly, when the light source or one or more of the illumination sources 706 illuminates, the drink cubes 704 may illuminate as well.

FIG. 8 is an illustration of an example illumination system employed within illumination drink cubes, according to one or more embodiments. In one or more embodiments, one or more drink cubes 802 can be equipped with or employ one or more illumination sources (e.g., LEDs), as shown. Here, one or more of the drink cubes 802 can illuminate or shine light or black light toward some of the illuminable liquid, thereby illuminating the UV material, illumination particles, or the illumination mixture included within the illuminable fluid, as described herein. Further, one or more of the light sources can be manually (e.g., switched on/off) or automatically (e.g., sensors) triggered. In one or more embodiments, one or more of the drink cubes can include illumination particles, an illumination source, a power source, or any combination thereof. This means that the drink cubes may appear to glow on their own, supplement illumination of the illuminable liquid, etc. Additionally, one or more of the drink cubes 802 may include different illumination sources, different illumination particles, or combinations thereof, such that one or more of the drink cubes 802 appear as a different color than one or more of the other drink cubes 802 or the illuminable fluid, beverage, etc.

FIG. 9 is an illustration of an example illumination system 900 employed in a freezer treat, according to one or more embodiments. In one or more embodiments, a freezer treat 900 or “freezer pop” can be equipped with a stick 902 that is frozen within a frozen treat 900 as shown. The frozen treat 900 can include illumination particles, an illumination mixture which can be frozen, or illuminable material such that a body of the frozen treat 900 can be illuminated. For example, when a button 904 is pushed, a series or plurality of LEDs, light sources, or illumination sources 906 can illuminate the freezer treat 900, thereby projecting UV light or black light, as indicated by the arrows. In operation, a frozen liquid can be illuminated, providing the freezer treat with a lighting effect.

In one or more embodiments, an illumination system (not shown) can be fitted into a bottle cap, lid, etc., thereby giving the illusion of lighted liquid upon pouring an illuminable liquid from the bottle, container, vessel, etc. For example, a liquor bottle (e.g., vodka bottle) can be equipped with an illumination pour device that can be manually or automatically activated as described herein. In one or more aspects, as the motion of illuminable liquid is detected, the nozzle can be illuminated, thereby providing UV light from an illumination source to the illuminable liquid. In other aspects, toggle, pressure or other triggering means can be provided to illuminate the illuminable liquid. Further, the bottle itself can be equipped with a UV light source which, when motion is detected, illuminates to provide a glowing effect to the illuminable liquid.

According to one or more aspects, an illumination system is provided, including a container comprising one or more illumination sources that emit ultraviolet (UV) light and a power source that powers one or more of the illumination sources. The system can include an illumination mixture comprising one or more illumination particles.

One or more of the illumination sources can illuminate one or more of the illumination particles upon activation of the power source. The container can be a vessel, cup, or bottle. The power source can be a battery. The illumination mixture can include a mixture of a liquid and one or more of the illumination particles. The container can include a motorized base that rotates. One or more of the illumination sources can attached to the motorized base. One or more of the illumination particles can be or include UV flakes or a UV powder. One or more of the illumination particles can appear green, blue, yellow, purple, red, or violet when exposed to the UV light or illumination sources. The power source can include one or more solar cells.

According to one or more aspects, an illumination system is provided, including a vessel comprising one or more illumination sources that emit ultraviolet (UV) light and a power source that powers one or more of the illumination sources. The system can include an illumination mixture comprising one or more illumination particles. The system can include a sensor that activates one or more of the illumination sources based on an input to the sensor. For example, the sensor is a light sensor that activates one or more of the illumination sources based on a light threshold. The sensor can be a volume sensor that adjusts an intensity of one or more of the illumination sources based on a volume of liquid within the vessel. The sensor can be a motion sensor that activates one or more of the illumination sources based on a detected motion. The power source can be a battery and one or more of the illumination particles can be UV flakes or a UV powder.

According to one or more aspects, an illumination system is provided, including one or more drink cubes comprising one or more illumination sources that emit ultraviolet (UV) light and one or more power sources that power one or more of the illumination sources. The system can include an illumination mixture comprising one or more illumination particles. One or more of the drink cubes appear as a different color from another drink cube when exposed to the UV light or illumination sources. The power source can be a battery and one or more of the illumination particles can be UV flakes or a UV powder.

Although the subject matter has been described in language specific to structural features or methodological acts, it is to be understood that the subject matter of the appended claims is not necessarily limited to the specific features or acts described above. Rather, the specific features and acts described above are disclosed as example embodiments.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or”. In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel.

Although the disclosure has been shown and described with respect to one or more implementations, equivalent alterations and modifications will occur based on a reading and understanding of this specification and the annexed drawings. The disclosure includes all such modifications and alterations and is limited only by the scope of the following claims.

What is claimed is:

1. An illumination system, comprising:
a container comprising:
one or more illumination sources that emit ultraviolet (UV) light; and
a power source that powers one or more of the illumination sources; and
an illumination mixture comprising one or more illumination particles.

2. The system of claim 1, wherein one or more of the illumination sources illuminate one or more of the illumination particles upon activation of the power source.

3. The system of claim 1, wherein the container is a vessel, cup, or bottle.

4. The system of claim 1, wherein the power source is a battery.

5. The system of claim 1, wherein the illumination mixture comprises a mixture of a liquid and one or more of the illumination particles.

6. The system of claim 1, wherein the container comprises a motorized base that rotates.

7. The system of claim 6, wherein one or more of the illumination sources are attached to the motorized base.

8. The system of claim 1, wherein one or more of the illumination particles are UV flakes or a UV powder.

9. The system of claim 1, wherein one or more of the illumination particles appears green, blue, yellow, purple, red, or violet when exposed to the UV light or illumination sources.

10. The system of claim 1, wherein the power source comprises one or more solar cells.

11. An illumination system, comprising:
a vessel comprising:
one or more illumination sources that emit ultraviolet (UV) light; and
a power source that powers one or more of the illumination sources;
an illumination mixture comprising one or more illumination particles; and
a sensor that activates one or more of the illumination sources based on an input to the sensor.

12. The system of claim 11, wherein the sensor is a light sensor that activates one or more of the illumination sources based on a light threshold.

13. The system of claim 11, wherein the sensor is a volume sensor that adjusts an intensity of one or more of the illumination sources based on a volume of liquid within the vessel.

14. The system of claim 11, wherein the sensor is a motion sensor that activates one or more of the illumination sources based on a detected motion.

15. The system of claim 11, wherein the power source is a battery.

16. The system of claim 11, wherein one or more of the illumination particles are UV flakes or a UV powder.

17. An illumination system, comprising:
one or more drink cubes comprising:
one or more illumination sources that emit ultraviolet (UV) light; and
one or more power sources that power one or more of the illumination sources; and
an illumination mixture comprising one or more illumination particles.

18. The system of claim 17, one or more of the drink cubes appear as a different color from another drink cube when exposed to the UV light or illumination sources.

19. The system of claim 17, wherein the power source is a battery.

20. The system of claim 17, wherein one or more of the illumination particles are UV flakes or a UV powder.
